(19) United States
(12) Patent Application Publication
(10) Pub. No.: US 2022/0088683 A1
(43) Pub. Date: Mar. 24, 2022

(54) METHOD OF ONLINE STRESS MEASUREMENT RESIDUAL DURING LASER ADDITIVE MANUFACTURING

(71) Applicant: THE REGENTS OF THE UNIVERSITY OF MICHIGAN, Ann Arbor, MI (US)

(72) Inventors: Jyotirmoy MAZUMDER, Ann Arbor, MI (US); Yi LU, Ann Arbor, MI (US); Guifang SUN, Ann Arbor, MI (US)

(21) Appl. No.: 17/429,118

(22) PCT Filed: Feb. 10, 2020
(86) PCT No.: PCT/US2020/017522

§ 371 Date: Aug. 6, 2021

Related U.S. Application Data
(60) Provisional application No. 62/803,896, filed on Feb. 11, 2019.

(51) Int. Cl. B22F 10/85; B22F 12/90; B22F 12/41; B22F 10/25; B33Y 50/02; G06T 7/00; G06F 30/23

(52) U.S. Cl. CPC B22F 10/85; B22F 12/90; B22F 12/41; B22F 10/25; B33Y 50/02; G06F 2113/10; G06F 30/23; G06T 2207/20024; G06T 2207/10016; G06T 2207/30164; G06T 7/0004

(57) ABSTRACT

A system and method for monitoring real time stress development of laser additive manufacturing. In some embodiments, the system comprises a laser machine, a laser deposition head, an illumination laser, a line laser, two CCD cameras, a spectrum meter, a computer, and an ultrasonic shot head. The CCD camera can record the molten pool height and the line laser can be directed behind the molten pool to measure the shape and/or height of the newly formed layer. The computer builds a real-time FEM model of the layer, calculates the displacement of the solidified surface, and then calculates the stress formed in the layer. The spectrum meter monitors for non-stress induced defects. The data is transferred into a computer to determine whether defects will occur and control the laser deposition and ultrasonic shot head to treat the area and prevent emergence of stress induced defect.

### CROSS-REFERENCE TO RELATED APPLICATIONS

This application claims the benefit of U.S. Provisional Application No. 62/803,896, filed on Feb. 11, 2019. The entire disclosure of the above application is incorporated herein by reference.

### FIELD

The present disclosure relates to laser additive manufacturing and, more particularly, to a system and method of monitoring and preventing residual stresses during laser metal deposition.

### BACKGROUND AND SUMMARY

This section provides background information related to the present disclosure which is not necessarily prior art. This section provides a general summary of the disclosure, and is not a comprehensive disclosure of its full scope or all of its features.

Laser additive manufacturing now provide a flexible way to produce customized three-dimensional functional components with complex configurations directly from metals, alloys, or composites powders. However, due to the consecutive thermal cycles and complex physical-chemical reactions, a complex thermal distribution within the solidified materials can occur. Moreover, due to these temperature gradients, uneven thermal contract and expansion can occur causing residual stress inside the solidified material. These stresses can result in defects that arise slowly and gradually—without obvious symptoms—that can unexpectedly cause abrupt breakage and/or failure. Unfortunately, such defects occur during the manufacturing process and are typically not repairable in post process. Accordingly, it should be appreciated that there is a need in the relevant art to provide a system and method to monitor and adjust for stress during laser additive manufacturing.

Currently, several patents offer a solution to monitor the in-situ residual stress during laser additive manufacturing. U.S. Patent Publication No. US20130101728A1 and U.S. Pat. No. 6,122,564 disclosed a method employing sensors mounted on the backside of a workpiece in order to monitor the strain change during manufacturing. However, unfortunately, these methods cannot directly reflect the stress state in the deposition layer. Likewise, U.S. Patent Publication No. US20170059529A1 discloses stress monitoring using ultrasonic waves. However, this method is easily interfered by the noise generated during the deposition process and is unable to reflect directly the stress distribution inside the deposition layer. Similarly, U.S. Patent Publication No. US20170067788A1 uses x-ray to detect the stress during the deposition process, yet suffers from the shortcoming that the x-ray is harmful to human body and can only detect the residual stress on the surface of the deposition layer. Still further, U.S. Pat. No. 9,555,475 discloses a method to mount clamps on the workpiece to detect the distortion of the workpiece and calculate the residual stress. This method cannot directly reflect the real stress state of the deposition layer. U.S. Pat. No. 9,696,142 uses a speckle interferometry method to detect residual stress distribution around molten pool. It calculates the stress change due to the change of interference pattern. However, it only contains the distortion and elongation caused by the thermal effect, not including the phase transformation, during the cooling process and only determines the stress in a constrained region, without considering the distribution on the whole workpiece.

In order to overcome the shortcoming of current technology, the present teachings provide a method that monitors the stress during the manufacturing process, accurately records the deformation during the deposition (also include the distortion caused by phase change), calculates the stress accumulation during the manufacturing process, and prevents the stress caused defects through online repairing.

More particularly, the present teachings are directed to a system and method for monitoring the online stress development of laser additive manufacturing. In some embodiments, the system can comprise a laser machine, a laser deposition head, an illumination laser, a line laser, two CCD cameras, a spectrum meter, a computer, and an ultrasonic shot head. In some embodiments, the method is based on computer vision and FEM calculation. It uses CCD to record the molten pool height and a line laser is pointed behind the molten pool to measure the shape of the newly formed layer. Another CCD is applied to record the shape of the line laser to measure the height of the solidified layer. The computer builds the real-time FEM model of the deposited layer, calculates the displacement of the solidified surface, and then calculates the stress formed in the deposited layer. The spectrum meter is used for the monitoring of the non-stress induced defects, such as pore, collapse, and as an extra criterion for defects determination. The detected data is transferred into a computer to do the calculation and make a judgement of whether defects will occur. Once the computer found stress in some points or area of the deposited layer is accumulated above a threshold, the computer stops the process. To this end, the computer can determine whether the stress is compressive or tensile. If the stress is compressive, the computer controls the laser to rescan the area to do a local heat treatment, thereby releasing the overage compressive stress. If the stress is tensile, the computer controls the ultrasonic hot head to induce compressive stress in to the area and then continue the deposition. If there is an abnormal in the spectrum signal, the computer can stop the process and use the CCD camera to check the abnormal position, and then use the laser deposition head to do a redisposition.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of a system according to the principles of the present teachings.

FIG. 2 is a schematic illustration of a portion of the system according to the principles of the present teachings.

FIG. 3 is a schematic illustration of nodes created on each section.

FIG. 4 is a schematic illustration of the process of building an FEM model.

FIGS. 5A-5C are schematic illustrations of the principles of stress calculation according to the principles of the present teachings.

FIG. 6 is a graph comparing measured and numerical simulated stress along a deposition layer where the molten pool is on the end of the deposition layer.

FIG. 7 is the schematic representation of a real time system according to the principles of the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In-Situ Residual stress measurement is a challenge for Additive manufacturing process. Residual stress often leads to defects such as cracking and deformation. The present teachings disclose a system and method for monitoring the online or real time stress development of laser additive manufacturing. In some embodiments, the system can comprise a laser machine, a laser deposition head, an illumination laser, a line laser, two CCD cameras, a spectrum meter, a computer, and an ultrasonic shot head. It uses CCD to record the molten pool height and a line laser is pointed behind the molten pool to measure the shape of the newly formed layer. A line laser is applied to measure the height of the solidified layer. The computer builds a real-time FEM model of the deposited layer, calculates the displacement of the solidified surface, and then calculates the stress formed in the deposited layer. The spectrum meter is used for the monitoring of the non-stress induced defects, and as an extra criterion for defect determination. All the detected data is transferred into a computer to do the calculation and make a judgement of whether defects will occur. Once the computer detects the defects may occur, it controls the laser deposition and ultrasonic shot head to treat the area and prevent the emerging of stress induced defect.

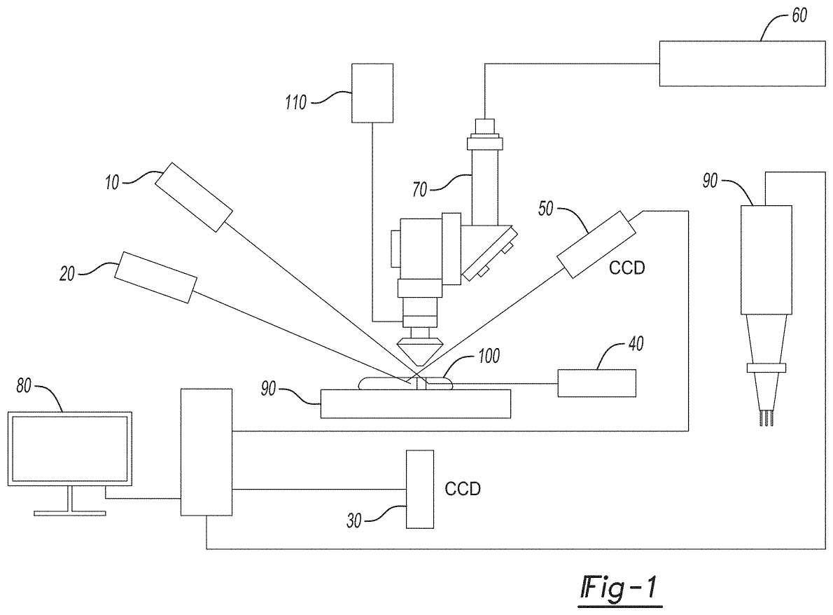

With reference to FIG. 1, in some embodiments, the system 2 can comprise a laser machine 60, a laser deposition head 70 outputting a laser, an illumination laser 10, a line laser 20, a CCD camera 50, a CCD camera 30, a spectrum meter 40, a computer 80, and an ultrasonic shot head 90. A workpiece or substrate 100 can be set on a CNC table. The laser head 70 can be set above the workpiece 100 and connected to laser machine 60 and a powder delivery system 110.

During manufacturing, the powder from power delivery system 110 passes through the laser deposition head 70 coaxially with laser, which is generated by laser machine 60. The laser from laser deposition head 70 melts the powder from power delivery system 110 and forms a molten pool on the substrate 100. As the laser deposition head 70 moves relative to substrate 100, the molten powder is solidified on the substrate 100 and forms a clad layer 104.

In some embodiments, the illumination laser 10 and CCD camera 30 can be used to monitor the molten pool height during manufacturing. To this end, in some embodiments, a light filter and/or a Neutral Density Filter (ND) can be mounted before the lens of the CCD camera 30 to protect the recorded image from the pollution of other wavelength lights emitted from the plasma and machining laser. The illumination laser 10 can be used for illumination of the molten pool area—in some embodiments, the illumination wavelength is matched with the filter(s), so that it is easy to create a gray scale image of the molten pool.

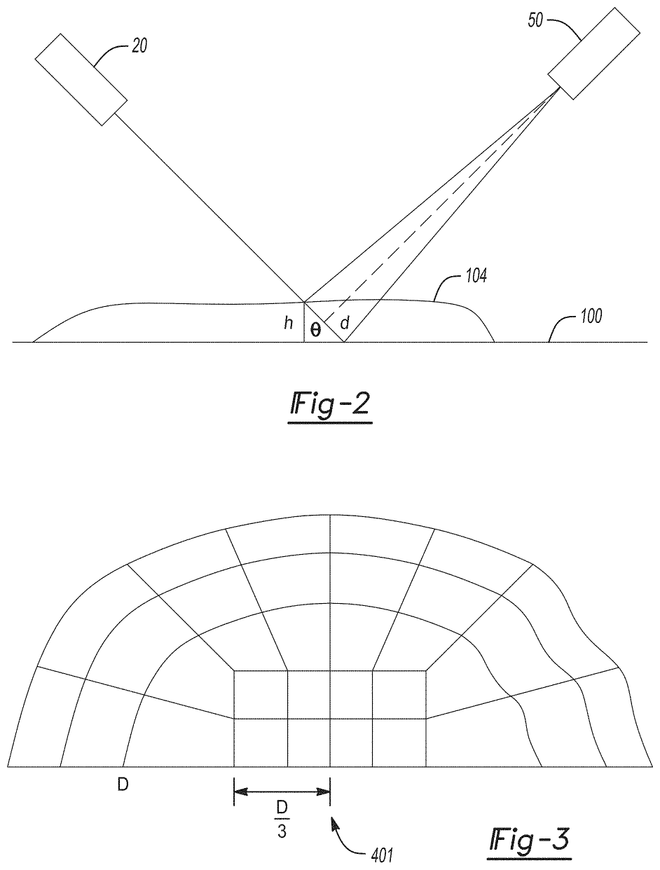

In some embodiments, as illustrated in FIG. 2, the line laser 20 can be used to measure the height of the solidified layer 104. In some embodiments, the wavelength of the line laser 20 is different from the wavelength of the illumination laser 10. In some embodiments, the line laser 20 in pointed a little behind the molten pool. The CCD camera 50 is used to record the shape of the line laser 20. A filter—matched with the wavelength of the line laser 20—is mounted before the CCD camera 50 to block the light from the illumination laser 10 and guarantee a good recording quality of the line laser.

With particular reference to FIG. 7, in some embodiments, an online motor device system 500 can comprise a hollow shaft stepping motor 501, line laser 20, CCD camera 30, CCD camera 50, Neutral Density Filter 503, and a light filter 502. The hollow shaft stepping motor 501 can be mounted at the laser deposition head 70, just above a nozzle 504. The line laser 20, CCDE camera 30, and CCD camera 50 can be mounted on the hollow shaft stepping motor 501. The Neutral Density Filter 503 and light filter 502 can be mounted in front of CCD camera 50. In some embodiments, another set of Neutral Density Filter and light filter can be mounted in front of the CCD camera 30. In some embodiments, the line laser 20 is aligned with CCD camera 50, and the sight line of CCD camera 30 is perpendicular to the line laser 20 and CCD camera 50. The hollow shaft stepping motor 501 continually adjusts the position of line laser 20, CCD camera 30, and CCD camera 50 to keep the line of line laser 20 and CCD camera 50 parallel to the laser scan direction.

With continued reference to FIG. 2, the height of the solidified layer 104 can be calculated by:

$$h = \frac{d}{sin θ}$$

The data of the line laser 20 and the molten pool height are sent to a computer 80 to form the shape of the workpiece 100.

In some embodiments, the FEM model is built according to the following method. The CCD recorded video is divided into a plurality of frames. According to the number of frames, the cladded layer is divided into the same number of sections as the frames. The shape of each section is taken as a half circle. As show in FIG. 3, ‘D’ is set as the divide on the radius, ⅓ of the ‘D’ is taken to form a well meshed rectangular area 401 on the core area of the section FIG. 3. The half circle is then divided into m segments, with equal angle. So there will be m+1 points along the circle, each point on the circle has a corresponding point on the edge on the rectangle and forms m+1 lines between these points. Nodes are created along these lines in clockwise. Once finished, the mesh of the section then moved to the next, until all nodes are created that are needed for the calculation. After creating the nodes, nodes in each section are connected and create elements of the clad layer.

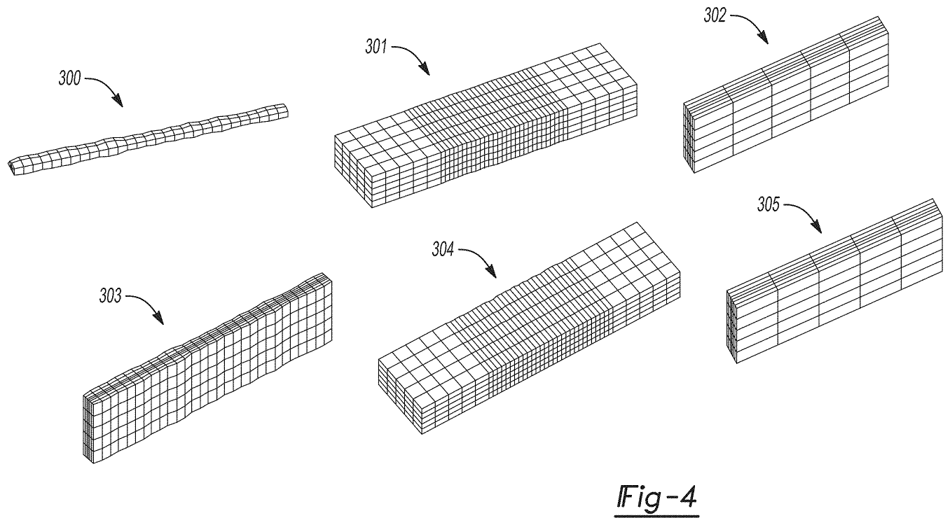

The FEM model of the substrate should be created according to the random edge of the clad layer 300 to guarantee a convergent calculation. In order to realize this, the substrate is divided into 5 parts i.e. the bottom 303, the front 302, the back 305, the left 301, and the right 304 (FIG. 4). The elements in each part is built to suit the random edge of the clad layer.

The stress calculation is based on the following principle:

The CCD camera records the molten pool height—this state is when the liquid first turns into solid state. Once can then hypnosis that in this state the stress in the solidified part has not formed yet. This state is taken as an energy stored state.

Then the line laser 20 records the shape of the solid state of the material. This state is taken as an energy released state.

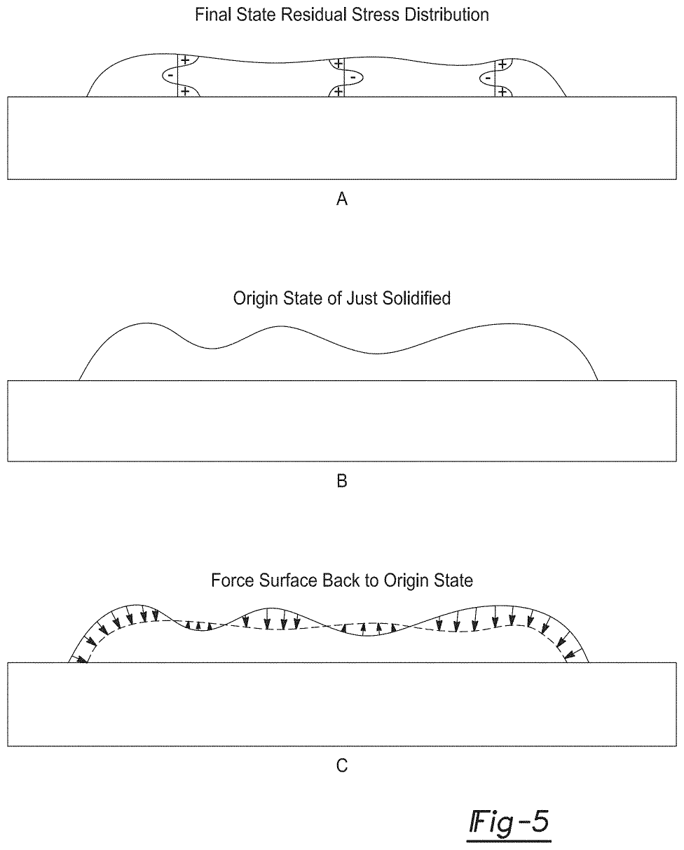

With reference to FIGS. 5A-5C, the state of the molten pool. Particularly, FIG. 5A illustrates the state containing the residual stress to be determined. FIG. 5B illustrates the shape of the molten pool just after solidification. It is presumed that the residual stress has not yet formed and this this state is a stress free state. FIG. 5C illustrates when the stress free surface (see FIG. 5B) is forced to fit the solidified surface (FIG. 5A). Due to the stress superposition principle, the stress in state A (FIG. 5A) can be expressed as:

σ^{(A)}(x,y,z)=σ^{(B)}(x,y,z)+σ^{(C)}(x,y,z)

According to the hypothesis the σ^{(B)} is 0 so the σ^{(A)}≈σ^{(C)}

The stress calculation method is based on following step:

First, the length of clad layer is according to the position of the line laser, the calculation is started when the line laser have traveled a certain distance (1 mm). Build the shape of the cladded layer according to the height of the molten pool.

Second, take the molten pool height as the original state, and the solid material height as an energy released state. Calculate the displacement of the surface.

Third, apply the displacement of the surface into the model, and calculate the stress that generates the deformation.

After each step, save the result of the last step, rebuild the model, substitute the result of the last step, and add displacement on the newly deposited part of the materials. Continue the calculation until the process is over.

The spectrum meter 40 is used for the monitoring of the non-stress induced defects, such as pore, collapse, and as an extra criterion for defects determination. All the detected data is transferred into the computer to do the calculation and make a judgment of whether defects will occur.

The threshold value of the residual stress is set to 70% of the tensile strength (or compressive strength) of the material. Once the computer detects the residual stress exceeds the threshold, the deposition is stopped, and the laser deposition head 70 is moved to the position where the abnormal stress appear. If the stress is compressive, decrease the laser power and perform local heat treatment at the abnormal area. If the stress is tensile, then move the ultrasonic peening head to the area and perform ultrasonic peening to induce compress stress into the material. If there are abnormalities in spectrum signal, stop the process, use CCD camera 30 to check the abnormal position, and use laser deposition head 70 to do a redisposition.

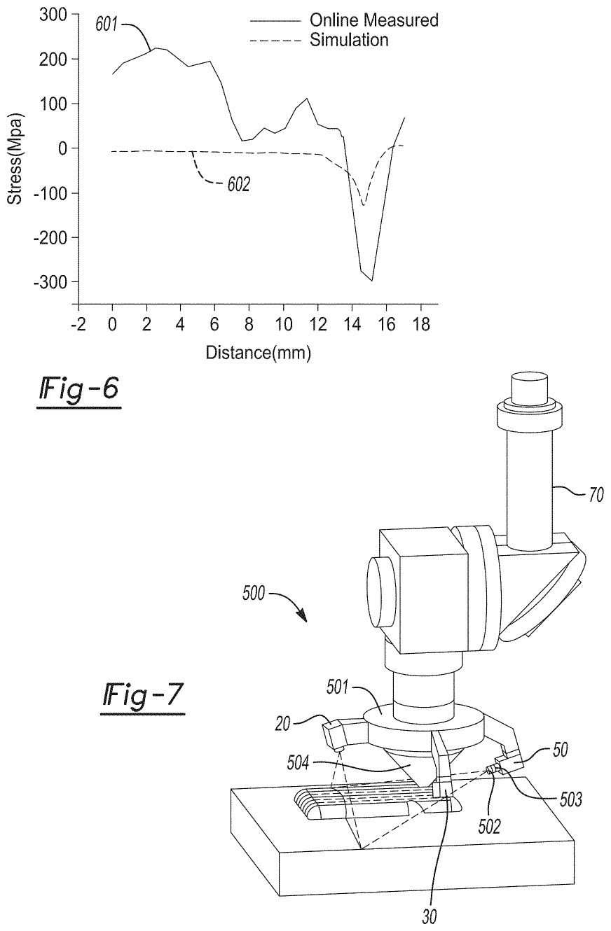

FIG. 6 is a graph of online measured stress and numerical simulated stress along the deposition layer where the molten pool is on the end of the deposition layer. The trend of the stress distribution is similar, and the measured stress is larger than the simulated results, which is good for the defects detection.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of online residual stress monitoring and defect repairing during laser metal deposition process, the method comprising:
measuring a height of molten material and a solidified layer;
building a real-time model of a clad layer based on the measured height of the molten materials and the solidified layer;
calculating a stress by analyzing a displacement of the solidified layer; and
monitoring non-stress induced defects.

2. The method according to claim 1, wherein the measuring is completed using a line laser, two CCD cameras, and an illumination laser.

3. The method according to claim 1, wherein the monitoring non-stress induced defects comprises monitoring non-stress induced defects using a spectrum meter.

4. A real-time FEM model building method comprising:
dividing a CCD recorded video into a plurality of frames;
dividing a cladded layer into the same number of sections as the plurality of frames;
assuming the shape of each section as a half circle;
forming a meshed rectangular area on ⅓ of the radius of the half circle at a core area of the section;
dividing the half circle into m segments with an equal angle such that there is m+1 points along the half circle, each point on the half circle has a corresponding point on the edge of the meshed rectangular area;
forming m+1 lines between the points to create nodes along these lines in clockwise, connect nodes in each section and create elements of a clad layer; and
creating the FEM model of the substrate according to a random edge of the clad layer to guarantee a convergent calculation by dividing into five parts including a bottom, a front, a back, a left, and a right.

5. A real time stress calculation method comprising:
initially completing the following steps:
determining a length of clad layer according to a position of a line laser by calculating when the line laser have traveled a certain distance and building a shape of the clad layer according to a height of a molten pool;
defining the height of the molten pool as an original state and a height of solidified material as an energy released state;
calculating a displacement of the surface of the molten pool and the surface of the solidified material;
applying the displacement of the surface into a model and calculating the stress generate during deformation; and
repeating the above steps and comparing a second calculated stress to the first calculated stress of the previous iteration of steps.

6. A real time monitoring device comprising:
a first CCD camera mounted on the hollow shaft stepping motor;
a second CCD camera mounted on the hollow shaft stepping motor;
a neutral density filter and a light filter mounted to at least one of the first CCD camera and the second CCD camera
a hollow shaft stepping motor;
a line laser mounted on the hollow shaft stepping motor and in line with the first CCD camera; and
at least one of the first CCD camera and the second CCD camera being perpendicular to the line laser,
wherein the hollow shaft stepping motor is configured to continually adjust the position of the line laser, the first CCD camera, and the second CCD camera to keep the line laser and at least one of the first CCD camera and the second CCD camera parallel to a laser scan direction.
